(19) United States
(12) Patent Application Publication
(10) Pub. No.: US 2013/0030922 A1
(43) Pub. Date: Jan. 31, 2013

(54) SYSTEM AND METHOD FOR SYNDICATING A CONVERSATION

(71) Applicants: Sami Shalabi, Winchester, MA (US); Jonathan Terleski, Mountain View, CA (US); Mussie Shore, Carlisle, MA (US); Cassandra Doll, Santa Clara, CA (US)

(72) Inventors: Sami Shalabi, Winchester, MA (US); Jonathan Terleski, Mountain View, CA (US); Mussie Shore, Carlisle, MA (US); Cassandra Doll, Santa Clara, CA (US)

(73) Assignee: GOOGLE INC., Mountain View, CA (US)

(21) Appl. No.: 13/190,803

(22) Filed: Jul. 26, 2011

(51) Int. Cl. G06F 15/16; G06Q 30/00

(52) U.S. Cl. 705/14.66; 709/206

(57) ABSTRACT

A system and method for syndicating comments received by a gadget that is embedded on different websites using a conversation application. The conversation application includes an authorization module, a code generator, an identity generator, a profile engine, a content parser, a syndication module, an analysis engine, an advertising engine and a newsletter engine. The content parser receives a comment posted by a user from a gadget embedded on a website and identifies the user and the website identifier. The syndication module identifies other websites that include the gadget. The syndication module then syndicates the content on the gadget embedded on the other websites. The analysis engine determines an interest of the user. The advertising engine provides advertisements to the website based on the interest of the user. The newsletter engine generates and sends newsletters to the user based on the interest of the user.

The specification relates to a system and method for enabling users of different websites to participate in a global conversation. In particular, the specification relates to syndicating content that is embedded on different websites, thus enabling users of each of those websites to participate in a global conversation.

### BACKGROUND

With the advent of social networking services, it has become increasingly popular for website developers to add a social layer to their websites. This allows the people who visit a website to interact, for example, by posting comments and having conversations with other people who share the same interests. Over the past few decades, there has been a drastic rise in the number of websites devoted to a single topic of interest. More often than not, people choose to view only a couple of websites due to varied reasons such as lack of time. Thus, people miss out on opportunities to participate in interesting conversations taking place on other websites with the same topic of interest.

Also, from a developer's perspective, such comments and conversations provide valuable information and feedback. With current methods the developers are at a disadvantage as they are restricted to receiving comments from people that only visit their websites. For example, it is difficult for a developer to know if a product being sold in a particular city would be well received internationally, as it is highly unlikely that a person who is not a customer or a member would post a comment on the website.

Thus, what is needed is a way to spread conversations across websites and make them global to benefit both users and developers of websites.

### SUMMARY OF THE INVENTION

In some examples, the specification describes a system and method for generating and embedding code that syndicates content received by a gadget that is embedded on different websites using a conversation application. In one embodiment, the conversation application enables a developer of a second website to embed a gadget that displays content generated on a first website.

The conversation application includes an authorization module, a code generator, an identity generator, a profile engine, a content parser, a syndication module, an analysis engine, an advertising engine and a newsletter engine. The content parser receives content posted by a user from the gadget embedded on the second website and identifies the user and a website identifier for the website where the content originated. The identity generator generates a website identifier for each website that is maintained in an index. The profile engine generates a profile for a user. The syndication module syndicates the content on the gadget embedded on the first website. The analysis engine determines an interest of the user by analyzing the content and user information. The analysis engine then sends the analysis to a developer of the first website. The advertising engine provides advertisements to the first website based on the interests associated with the user. The newsletter engine generates and sends a newsletter to the user based on the interests associated with the user if the user is a public member.

The conversation application syndicates content across multiple websites, which allows visitors of different websites to benefit from the same content.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram illustrating one embodiment of a system for syndicating content received by a gadget that is embedded on different websites.

FIG. 2 is a block diagram illustrating one embodiment of a conversation element.

FIG. 3A is a graphic representation of a first embodiment for syndicating content received by a gadget that is embedded on different websites.

FIG. 3B is a graphic representation of a second embodiment for syndicating content received by a gadget that is embedded on different websites.

FIG. 4 is a graphic representation of one embodiment of a first website including a user interface for a gadget.

FIG. 5 is a graphic representation of one embodiment of the settings associated with embedding a gadget from a first website on to a second website.

FIG. 6 is a graphic representation of one embodiment of a first website including a code that is required by a developer for embedding the gadget on a second website.

FIG. 7 is a graphic representation of one embodiment of the gadget embedded on a second website.

FIG. 8 is a graphic representation of one embodiment of a user interface for a user to sign in and post content.

FIG. 9 is a flow diagram illustrating a first embodiment of a method for syndicating content received by a gadget that is embedded on different websites.

FIG. 10 is a flow diagram illustrating a second embodiment of a method for syndicating content received by a gadget that is embedded on different websites.

### DETAILED DESCRIPTION

A system and method for syndicating content received by a gadget that is embedded on different websites. In the following description, for purposes of explanation, numerous specific details are set forth in order to provide a thorough understanding of the specification. It will be apparent, however, to one skilled in the art that embodiments of the specification can be practiced without these specific details. In other instances, structures and devices are shown in block diagram form in order to avoid obscuring the specification. The specification applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The description also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

### System Overview

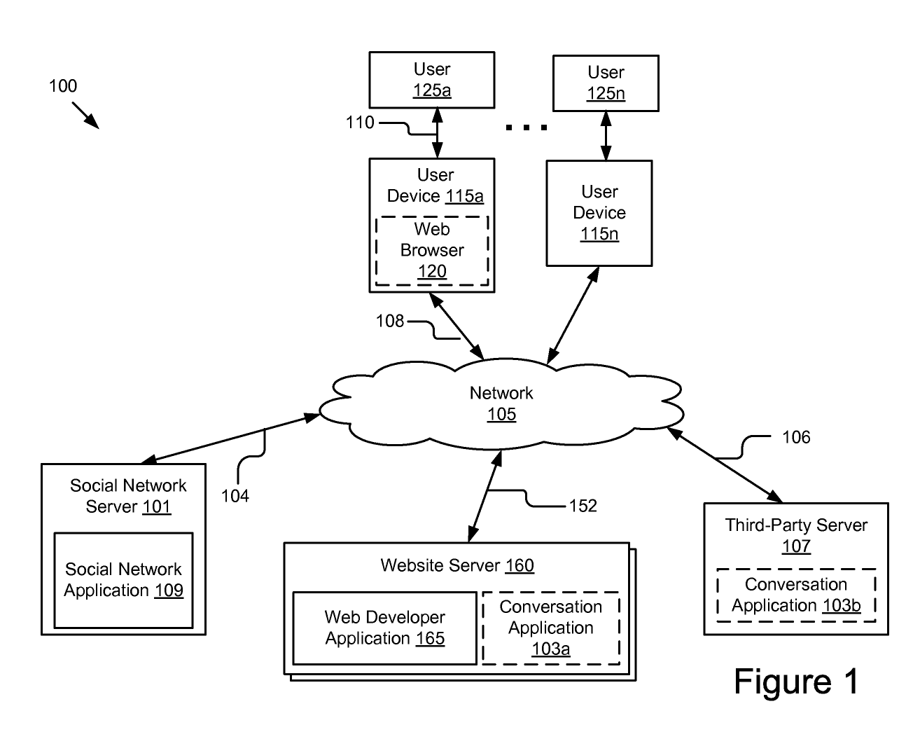

FIG. 1 illustrates a block diagram of a system 100 for syndicating content received by a gadget that is embedded on different websites according to one embodiment. The illustrated system 100 includes user devices 115a, 115n that are accessed by users 125a, 125n, a social network server 101, a website server 160 and a third-party server 107. In FIG. 1 and the remaining figures, a letter after a reference number, such as “115a” is a reference to the element having that particular reference number. A reference number in the text without a following letter, such as “115,” is a general reference to any or all instances of the element bearing that reference number. In the illustrated embodiment, these entities are communicatively coupled via a network 105.

The user devices 115a, 115n in FIG. 1 are used by way of example. While only two user devices are illustrated, persons of ordinary skill in the art will recognize that any number of user devices is available to any number of users. Further, while only one network 105 is coupled to the user devices 115a, 115n, the social network server 101, the website server 160 and the third-party server 107, in practice any number of networks 105 can be connected to the entities. Furthermore, while only one third-party server 107 and one social network server 101 are shown, the system 100 could include one or more third-party servers 107 and one or more social network servers 101.

The user device 115a, 115n is any computing device that includes a memory and a processor. For example, the user device 115a, 115n includes a personal computer, a laptop, a tablet or a mobile device such as a cellular phone, a personal digital assistant or a smart phone. In one embodiment, the user device 115a includes a web browser 120. The web browser 120 is code and routines stored in a memory and executed by a processor of the user device 115a. For example, the browser 120 is a browser application that loads websites hosted by the website server 160. The user 125a, accesses the user device 115a via signal line 110. The user device 115a is connected to the network 105 via signal line 108.

In one embodiment, the conversation application 103a is stored on a website server 160, which is connected to the network 105 via signal line 152. The website server 160 also includes a web developer application 165 that generates content for a website. Each website is stored on a separate website server 160. Persons of ordinary skill in the art will recognize that each website server 160 contains a conversation application 103a or only some of the website servers 160 contain a conversation application 103a.

The conversation application 103a generates, for example, a gadget with self contained software that is displayed on a website that includes an online community. The gadget is displayed on the website generated by the web developer application 165. Although the conversation application 103a is illustrated as a separate application, in one embodiment the conversation application 103a is a component of the web developer application 165.

In another embodiment, the conversation application 103b is stored on a third-party server 107. The third-party server 107 is connected to the network 105 via signal line 106. The conversation application 103b communicates with the web developer application 165 via the network 105 to provide the gadget for incorporation into the webpage. In yet another embodiment, the conversation application 103b that is operable on the third-party server 107 also includes software for generating the web content instead of having a separate application as illustrated in the website server 160 example. Persons of ordinary skill in the art will recognize that the conversation application 103 can be stored in any combination on the devices and servers.

The social network server 101, which is coupled to the network 105 via signal line 104, contains a social network application 109. A social network is any type of social structure where the users are connected by a common feature, for example, Orkut. The common feature includes friendship, family, work, an interest, etc. The common features are provided by one or more social networking systems, such as those included in the system 100, including explicitly-defined relationships and relationships implied by social connections with other online users.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or includes portions of a telecommunications network for sending data in a variety of different communication protocols. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, email, etc.

In one embodiment, the conversation application 103 enables a developer of a second website to embed the gadget on a second website that was initially embedded on to a first website. The conversation application 103 receives content posted by users from the gadget embedded on the second website. The conversation application 103 then syndicates the received content on the gadget embedded on the first website. Syndication includes transmitting the content that is displayed on the second website to the first website for display. As a result of syndication, websites with the embedded gadget display the same content. Thus, when a user comments on a second website and then visits the first website, the user expects to view the same content and is able to seamlessly continue having a conversation with other gadget users.

In another embodiment, the conversation application 103 analyzes the content received by the gadget embedded on a website and provides, for example, newsletters to the users, advertisements for the website, etc., based on the analysis. Persons of ordinary skill in the art will recognize that the gadget can be embedded on any number of websites and that content received on any website can be syndicated in all the websites that include the gadget.

The gadget is software and routines that, when executed by a processor, provides a service (i.e., web content) that is embedded on a website. In one embodiment, the gadget provides a service without needing an independent application to be launched, but instead is run in an environment that manages multiple gadgets. In one embodiment, the website is registered with the third-party server 107 and the third-party server 107 provides the website with access to different services including the gadget. For example, the website is registered with Google® Friend Connect and Google® Friend Connect provides the website with access to a plug-in service.

### Conversation Application 103

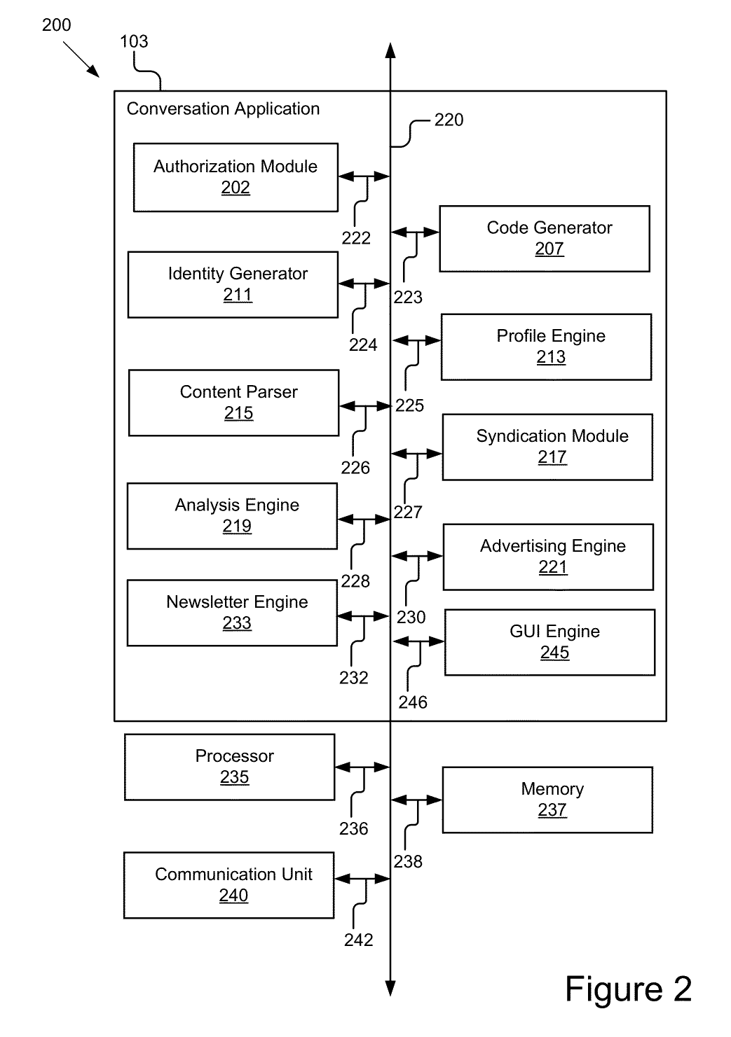

Referring now to FIG. 2, the conversation application 103 is shown in more detail. FIG. 2 is a block diagram of a computing device 200 that includes the conversation application 103, a memory 237, a processor 235 and a communication unit 240 that are coupled to the bus 220. In one embodiment, the computing device 200 device is a website server 160. In another embodiment, the computing device 200 is a third-party server 107.

The processor 235 comprises an arithmetic logic unit, a microprocessor, a general purpose controller or some other processor array to perform computations and provide electronic display signals to a display device. The processor 235 is coupled to the bus 220 for communication with the other components via signal 236. The Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible.

The memory 237 stores instructions and/or data that may be executed by processor 235. The memory 237 is coupled to the bus 220 for communication with the other components via signal line 238. The instructions and/or data may comprise code for performing any and/or all of the techniques described herein. The memory 237 may be a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis.

The communication unit 240 receives data from the third-party server 107, the website server 160 and/or the user device 115 depending upon where the conversation application 103 is stored. The communication unit 240 transmits the data to the conversation application 103. The communication unit 240 is coupled to the bus 220 via signal line 242. In one embodiment, the communication unit 240 includes a port for direct physical connection to the network 105 or to another communication channel. For example, the communication unit 240 includes a USB, SD, CAT-5 or similar port for wired communication with the network 105. In another embodiment, the communication unit 240 includes a wireless transceiver for exchanging data with the network 105, or with another communication channel, using one or more wireless communication methods, such as IEEE 802.11, IEEE 802.16, BLUETOOTH®, near field communication (NFC) or another suitable wireless communication method. In one embodiment, the communication unit 240 includes a NFC chip that generates a radio frequency (RF) for short-range communication.

In one embodiment, the conversation application 103 comprises an authorization module 202, a code generator 207, an identity generator 211, a profile engine 213, a content parser 215, a syndication module 217, an analysis engine 219, an advertising engine 221, a newsletter engine 233 and a graphical user interface (GUI) engine 245.

The authorization module 202 is software including routines for authorizing a request from a developer of a website to embed a gadget from another website. In one embodiment, the authorization module 202 is a set of instructions executable by the processor 235 to provide the functionality described below for authorizing a request from developer to embed a gadget. In another embodiment, the authorization module 202 is stored in the memory 237 of the computing device 200 and is accessible and executable by the processor 235. In either embodiment, the authorization module 202 is coupled to the bus 220 for cooperation and communication with the processor 235, the GUI engine 245, the communication unit 240, the code generator 207, the identity generator 211, the syndication module 217 and other components of the computing device 200 via signal line 222.

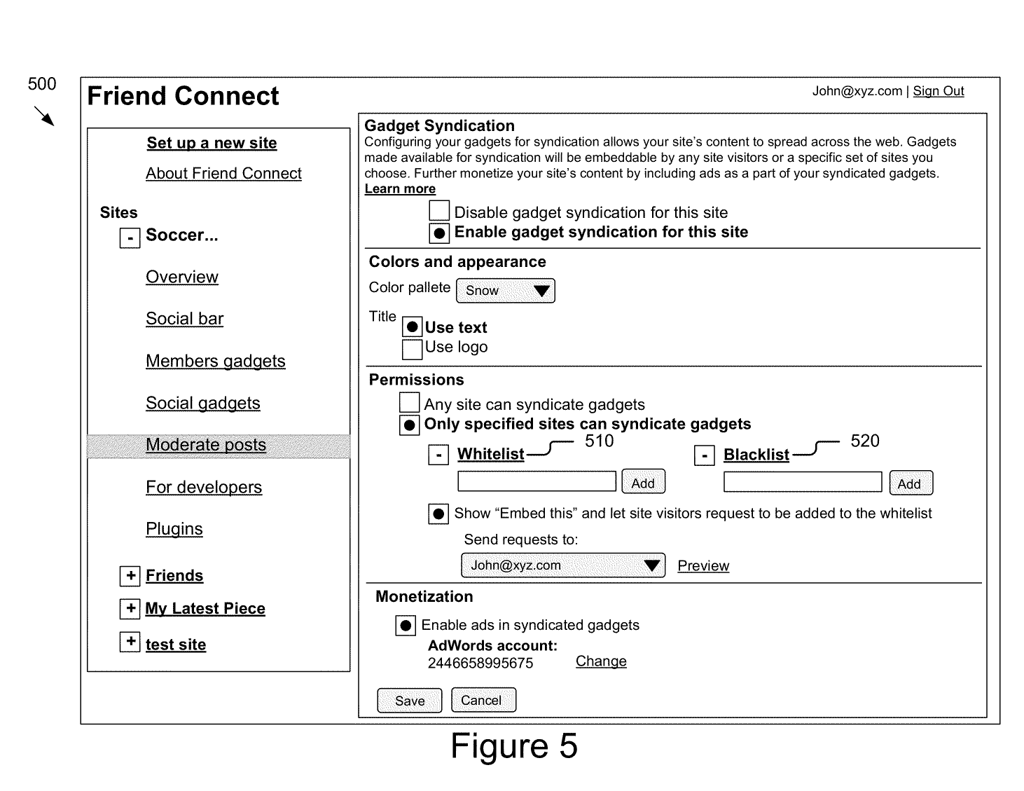

According to one embodiment, the authorization module 202 receives a request via the communication unit 240 or via a user interface generated by the GUI engine 245 from a developer of a second website to embed a gadget embedded on a first website onto the second website. The authorization module 202 authorizes the request by determining the settings associated with the gadget embedded on the first website and determining whether the gadget can be embedded on any website, determining whether the second website has been black listed or white listed, verifying an identity of the developer of the second website, determining an Internet Protocol address, etc. An example of the settings associated with a gadget embedded on a website is illustrated in FIG. 5.

The code generator 207 is software including routines for generating a code for embedding a gadget on a website. In one embodiment, the code generator 207 is a set of instructions executable by the processor 235 to provide the functionality described below for generating an embed code for embedding the gadget. In another embodiment, the code generator 207 is stored in the memory 237 of the computing device 200 and is accessible and executable by the processor 235. In either embodiment, the code generator 207 is coupled to the bus for cooperation and communication with the processor 235, the GUI engine 245, the communication unit 240, the authorization module 202 and other components of the computing device 200 via signal line 223. In one embodiment, the code generator 207 generates code that is displayed on the user interface generated by the GUI engine 245. In another embodiment, the code is transmitted to the requestor via the communication unit 240.

The Identity (ID) generator 211 is software including routines for generating a website identifier for a website. In one embodiment, the ID generator 211 is a set of instructions executable by the processor 235 to provide the functionality described below for generating a website identifier for a website. In another embodiment, the ID generator 211 is stored in the memory 237 of the computing device 200 and is accessible and executable by the processor 235. In either embodiment, the ID generator 211 is adapted for cooperation and communication with the processor 235, the memory 237, the authorization module 202, the syndication module 217 and other components of the computing device 200 via signal line 224.

The authorization module 202 notifies the ID generator 211 once the request for embedding the gadget on the second website is authorized. The ID generator 211 receives the notification and generates a website identifier for the second website. In one embodiment, the ID generator 211 creates an index comprising an identifier for the gadget, the website identifier for the second website and the website identifier for the first website where the gadget was first embedded. A person with ordinary skill in the art will recognize that the index can comprise the website identifiers of any number of websites that are embedded with the gadget. In another embodiment, where an index already exists for a gadget, the ID generator 211 adds the newly generated website identifier to the existing index. The ID generator 211 stores the website identifiers and the indexes in the memory 237.

The profile engine 213 is software including routines for generating a profile for a user to sign-in to websites and post content. Content includes text, audio, video, a photo, a response to a poll or a questionnaire or any other content known to a person with ordinary skill in the art. In one embodiment, the profile engine 213 is a set of instructions executable by the processor 235 to provide the functionality described below for generating a profile. In another embodiment, the profile engine 213 is stored in the memory 237 of the computing device 200 and is accessible and executable by the processor 235. In either embodiment, the profile engine 213 is coupled to the bus 220 for cooperation and communication with the processor 235, the memory 237, the communication unit 240, the content parser 215, the analysis engine 219, the newsletter engine 233 and other components of the computing device 200 via signal line 225. The profile engine stores the generated profiles in the memory 237.

In one embodiment, the profile engine 213 generates a user profile that is viewable by other members of the same service. The user profile includes the user's name (real or anonymous) and other user attributes such as a list of websites that the user subscribes to, links to the user's content, a list of the user's interests, images, demographic information, etc. If the user does not want to provide an email address to associate with the account, in one embodiment the user posts anonymously and the profile engine 213 recognizes the user based on the internet protocol (IP) address for the user device 115 or from a cookie that is stored on the user device 115.

The content parser 215 is software including routines for receiving content posted by a user via the communication unit 240 from a gadget embedded on a website and for identifying the user and the website identifier associated with the content. In one embodiment, the content parser 215 is a set of instructions executable by the processor 235 to provide the functionality described below for receiving content and identifying the user. The content includes a thread, a comment, an image, a video, etc. In another embodiment, the content parser 215 is stored in the memory 237 of the computing device 200 and is accessible and executable by the processor 235. In either embodiment, the content parser 215 is coupled to the bus 220 for cooperation and communication with the processor 235, the GUI engine 245, the communication unit 240, the profile engine 213, the syndication module 217 and other components of the computing device 200 via signal line 226.

The syndication module 217 is software including routines for syndicating content received via the communication unit 240 from a gadget embedded on different websites. In one embodiment, the syndication module 217 is a set of instructions executable by the processor 235 to receive user content and an identity of the website associated with the user content from the content parser 215 and transmit the user content to the other gadgets via the communication unit 240. In another embodiment, the syndication module 217 is stored in the memory 237 of the computing device 200 and is accessible and executable by the processor 235. In either embodiment, the syndication module 217 is coupled to the bus 220 for cooperation and communication with the processor 235, the GUI engine 245, the communication unit 240, the content parser 215 and other components of the computing device 200 via signal line 227.

The analysis engine 219 is software including routines for analyzing the content received via the communication unit 240 and information of the users that posted the content. In one embodiment, the analysis engine 219 is a set of instructions executable by the processor 235 to analyze the content received and demographic information of the users. In another embodiment, the analysis engine 219 is stored in the memory 237 of the computing device 200 and is accessible and executable by the processor 235. In either embodiment, the analysis engine 219 is coupled to the bus 220 for cooperation and communication with the processor 235, the GUI engine 245, the communication unit 240, the profile engine 213, the content parser 215, the advertising engine 221, the newsletter engine 223 and other components of the computing device 200 via signal line 228.

The analysis engine 219 analyzes the content posted by a user. The analysis engine 219 also obtains and analyzes profile information, such as demographic information of the user.

The analysis engine 219 analyzes the profile information and user-submitted content to infer whether the user is interested in a particular topic. For example, the analysis engine 219 analyzes the content to determine whether the user is making a positive or negative statement. An example of a positive statement is: “Indian food is delicious.” An example of a negative statement is: “Cheese burgers are unhealthy.” From these statements, the analysis engine 219 infers that the user likes Indian cuisine and does not like cheese burgers. In one embodiment, the analysis engine 219 sends the analysis (e.g., as a statistical report) to the developers of the websites via the communication unit 240. In one embodiment, the user information is anonymized so that personal identifying information is not included. Such analyses are advantageous as they provide valuable feedback for the developers. The developers can use the analysis, for example, to modify their websites to cater to the likes and needs of the users, send personalized newsletters or promotional offers to their users, etc.

The advertising engine 221 is software including routines for providing advertisements to a website that includes the embedded gadget. In one embodiment, the advertising engine 221 is a set of instructions executable by the processor 235 for retrieving advertisements from the memory 237 that match the user interests and providing the advertisements to other websites. In one embodiment, the user information is anonymized and the advertisements are based on a determination of what a group of anonymous users with similar interests enjoy. In another embodiment, the advertising engine 221 is stored in the memory 237 of the computing device 200 and is accessible and executable by the processor 235. In either embodiment, the advertising engine 221 is coupled to the bus 220 for cooperation and communication with the processor 235, the GUI engine 245, the communication unit 240, the analysis engine 219 and other components of the computing device 200 via signal line 230.

The advertising engine 221 uses the inferences made by the analysis engine 219 to provide advertisements to a website. The advertising engine 221, based on the above mentioned example, would provide advertisements on Indian restaurants available in the locality of the user, local grocery shops that sell Indian spices, etc. In another embodiment, instead of providing the advertisements directly, the advertising engine 221 transmits an advertising code that is used to retrieve advertisements from an advertising server.

The newsletter engine 233 is software including routines for generating and sending a newsletter to a user. In one embodiment, the newsletter engine 233 is a set of instructions executable by the processor 235 for generating and sending newsletters. In another embodiment, the newsletter engine 233 is stored in the memory 237 of the computing device 200 and is accessible and executable by the processor 235. In either embodiment, the newsletter engine 233 is coupled to the bus 220 for cooperation and communication with the processor 235, the profile engine 213, the content parser 215, the analysis engine 219 and other components of the computing device 200 via signal line 232.

The newsletter engine 233 uses the inferences made by the analysis engine 219 to generate and send personalized newsletters to a user via the communication unit 240 or to display the newsletters as part of the user interface generated by the GUI engine 245. The newsletter engine 233, based on the above mentioned example, would generate a newsletter that includes a report of Indian restaurants and grocery shops available in the locality of the user, recipes for cooking Indian food, news articles, etc.

The GUI engine 245 is software including routines for generating a user interface. The GUI engine 245 receives information for generating a profile for the user and transmits the information to the profile engine 213. In one embodiment the GUI engine 245 receives a request for the code for embedding the gadget on a website that is generated by the code generator 207. Once the authorization module 202 provides authorization and the code generator 207 generates the code, the GUI engine 245 displays the code. In another embodiment, the GUI engine 245 generates a user interface for a developer to select advertisements generated by the advertising engine 221 and newsletters generated by the newsletter engine 233.

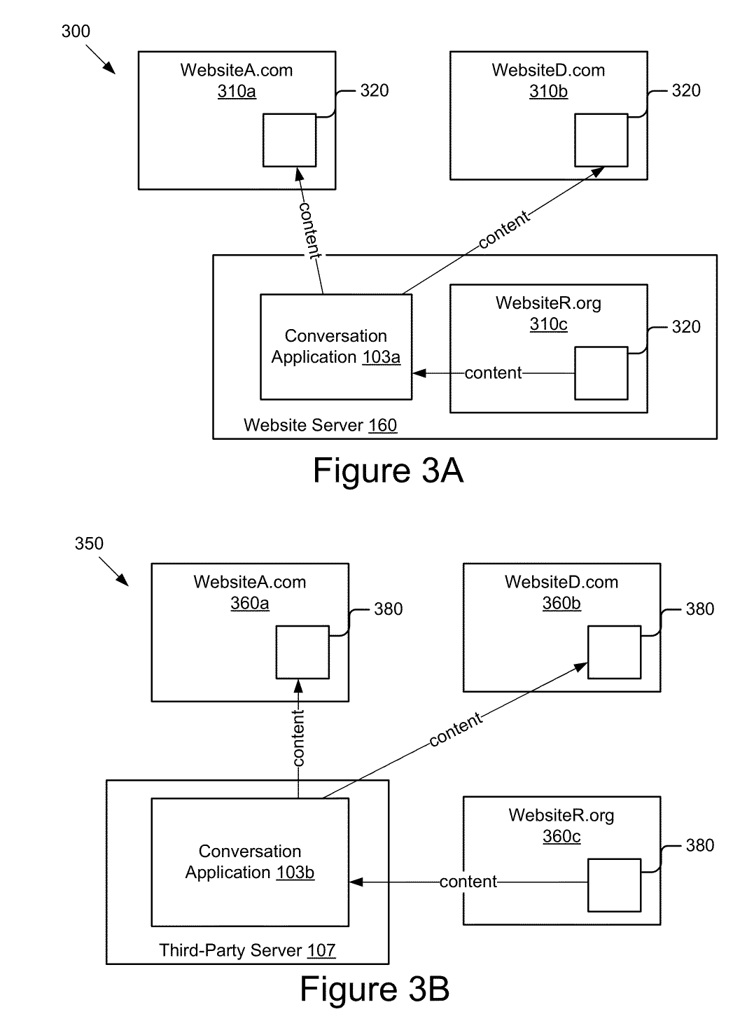

Referring now to FIGS. 3A-3B, various embodiments will be described. FIG. 3A is a graphic representation 300 of a first embodiment for syndicating content received by a gadget embedded on different websites. The illustrated embodiment includes websites 310a, 310b and 310c that have a gadget 320 embedded in them. While only three websites are illustrated, persons of ordinary skill in the art will recognize that any number of websites can be embedded with the gadget 320. The websites 310a, 310b and 310c are hosted by separate website servers 160. In this embodiment, the conversation application 103 is stored on a website server 160 that also hosts WebsiteR.org. When the gadget 320 embedded on the website 310c receives content from a user, the conversation application 103 syndicates the received content on the gadget 320 embedded on websites 310a and 310b. Thus users of websites 310a and 310b can view and reply to the content from their respective websites.

FIG. 3B is a graphic representation 350 of a second embodiment for syndicating content received by a gadget embedded on different websites. Similar to the above example, the illustrated embodiment includes three websites 360a, 360b and 360c that have a gadget 380 embedded in them. The illustrated embodiment also includes a third-party server 107 in which the conversation application 103 is stored. When the gadget 380 embedded on the website 360c receives content from a user, the conversation application 103 receives the content via network 105 (not shown) and syndicates it by transmitting the content to the gadget embedded on websites 360a and 360b for display.

### Embedding a Gadget on a Website

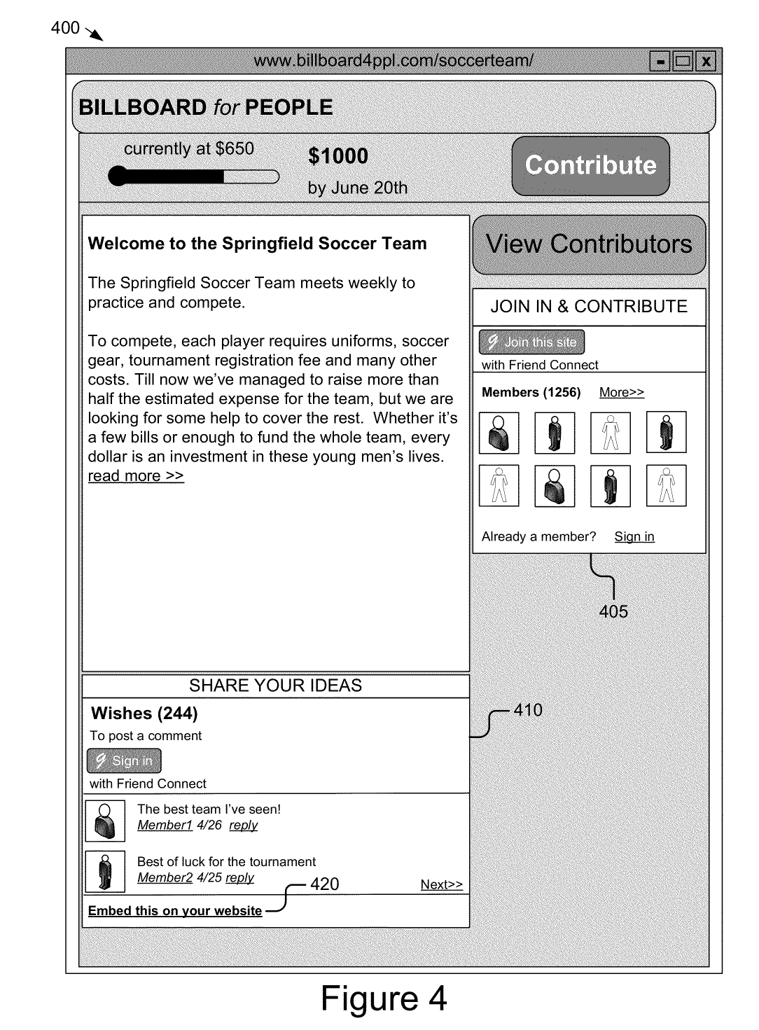

FIGS. 4-7 illustrate a user interface for embedding a gadget embedded on a first website on to a second website. FIG. 4 is a graphic representation 400 of a first website. In the illustrated example, the first website is called Billboard for People, which includes embedded gadgets. The embedded gadgets are a members gadget 405 displaying the members of the website and a comments gadget 410 that allows the members and users of the website to post comments. When a developer of a second website comes across the first website and decides to embed the comments gadget 410 and its contents on the second website, the developer submits a request, for example, by clicking on the link 420.

The authorization module 202 receives the request and determines whether the comments gadget 410 can be embedded on the second website by verifying the settings of the first website. FIG. 5 illustrates a graphic representation 500 of a user interface generated by the GUI engine 245 that displays the settings configured for the first website. In this example, the authorization module 202 authorizes the request if the second website is listed in the white list 510 and does not authorize the request if the second website is listed in the black list 520. If the second website is not listed in either of the two lists, the authorization module 202 sends an e-mail including the request to the developer.

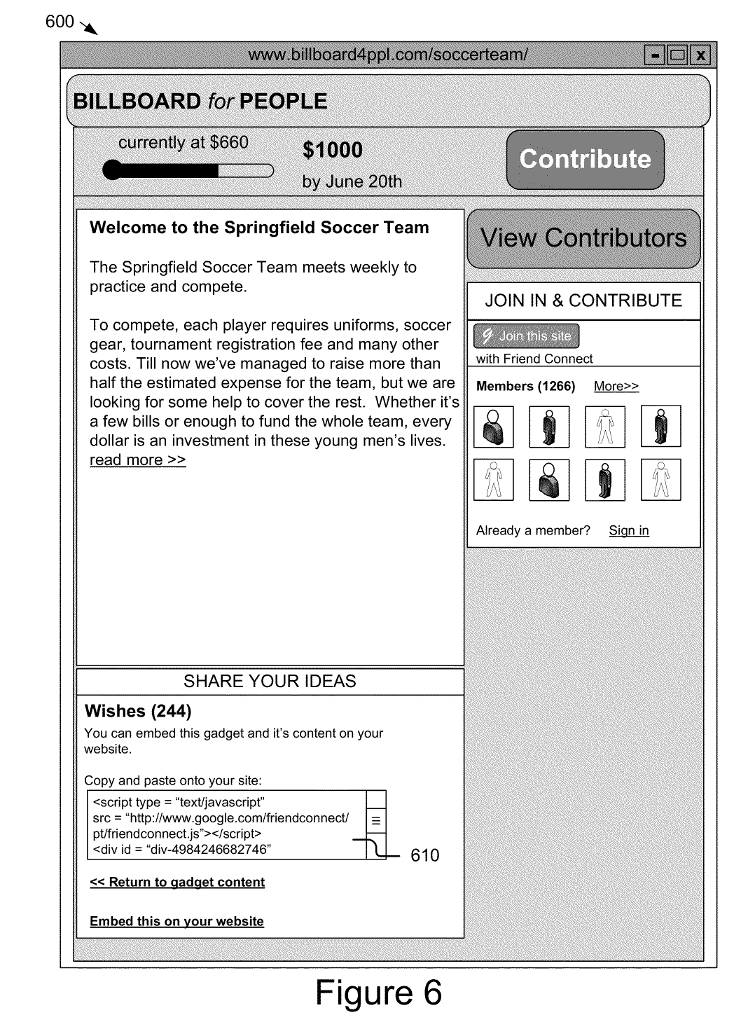

Once the authorization module 202 has authorized the request, the code generator 207 generates a code for embedding the comments gadget 410 on the second website. Also, the ID generator 211 generates a website ID that is unique for the second website. FIG. 6 is a graphic representation 600 of the user interface generated by the GUI engine 245 for the first website including the code 610 generated by the code generator 207. In this example, the generated code 610 is a Hyper Text Markup Language (HTML) code that the developer can copy and paste into the coding for the second website. In one embodiment, the code generator 207 automatically embeds the code in the second website so that the user does not have copy and paste it. Persons of ordinary skill in the art will recognize that the code can be generated in any computer programming language such as HTML, JavaScript, etc.

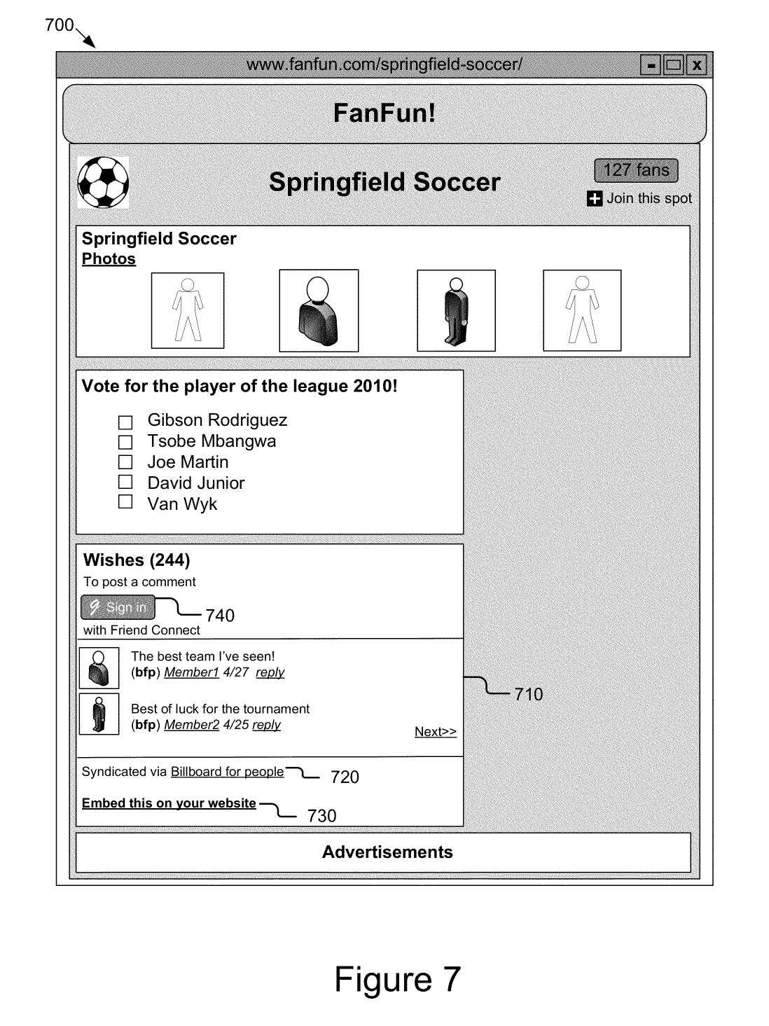

FIG. 7 is a graphic representation 700 of the second website including the comments gadget 710 and its contents that is embedded from the first website. The comments gadget 710 includes a link 720 to the first website so that the users of the second website are aware of the source of the comments gadget 710. This helps spread branding of a product for viral acceptance. Furthermore, the comments gadget 710 includes a link 730 similar to the link 420, using which other developers can submit requests for embedding the gadget on their websites.

### Allowing Users to Post Content

Once the developer has embedded the comments gadget on the second website, the comments gadget is ready to receive comments from its members and users. To be able to post a comment a member submits a request to sign in to the comments gadget with a profile, for example, by clicking on a link 740. In one embodiment, the profile includes posting as an anonymous user. When a new user without a profile submits a request, the profile engine 213 creates a profile for the new user.

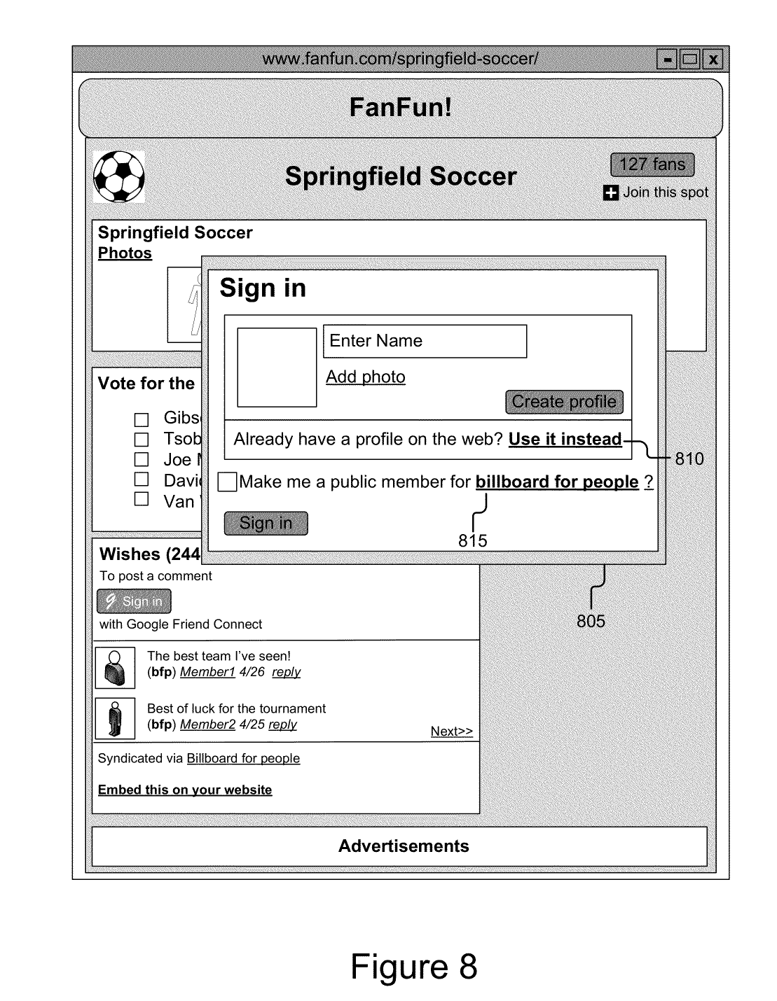

FIG. 8 illustrates one embodiment of a user interface 805 generating by the GUI engine 245 for requesting information from the new user to create a profile. In the illustrated example, the user interface 805 requests information such as a user name and a photo. A person with ordinary skill in the art will recognize that any user information such as a location, a date of birth, a password, etc., can be requested for generating a profile for the user. Using the information inputted by the user, the profile engine 213 generates a profile for the user that is displayed by the GUI engine 245. The user then uses this profile to sign in and post comments. The GUI engine 245 provides an option 815 for the user to become a member of the first website from which the comments gadget was embedded. By becoming a member the user is entitled to more privileges of the website such as personalizing the website, receiving newsletters, promotional offers, etc.

In one embodiment, the user chooses to sign in to the comments gadget using an existing profile by clicking the link 810. The existing profile is a profile with another website, a social network, an e-mail account or any other profile on the web known to a person of ordinary skill in the art. This model for allowing users to post content using any user profile without having to become members of a website is advantageous. For example, if a user wants to post a negative comment on the comments gadget, it is likely that the user would not want to become a member or create a profile with the website.

### Methods

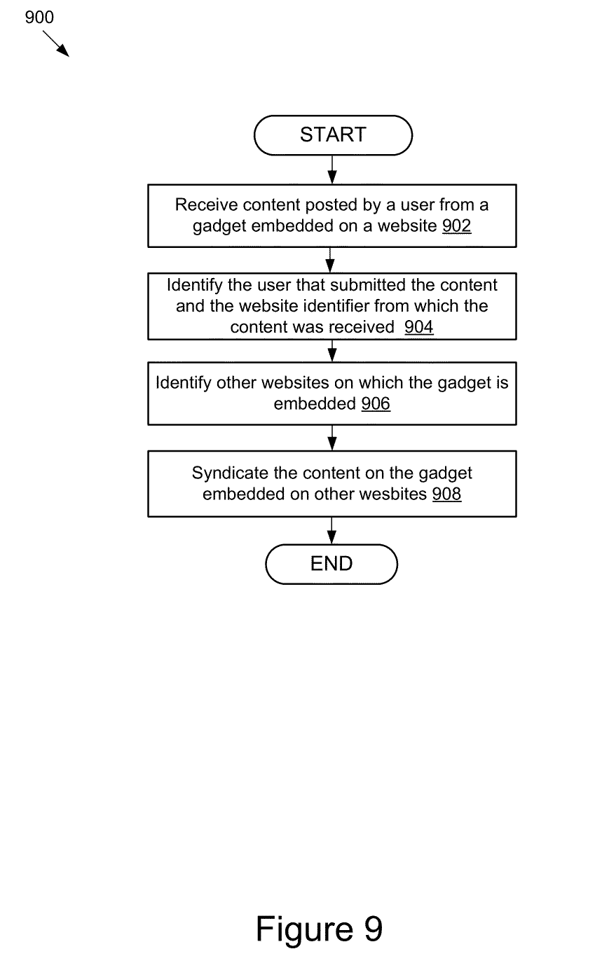

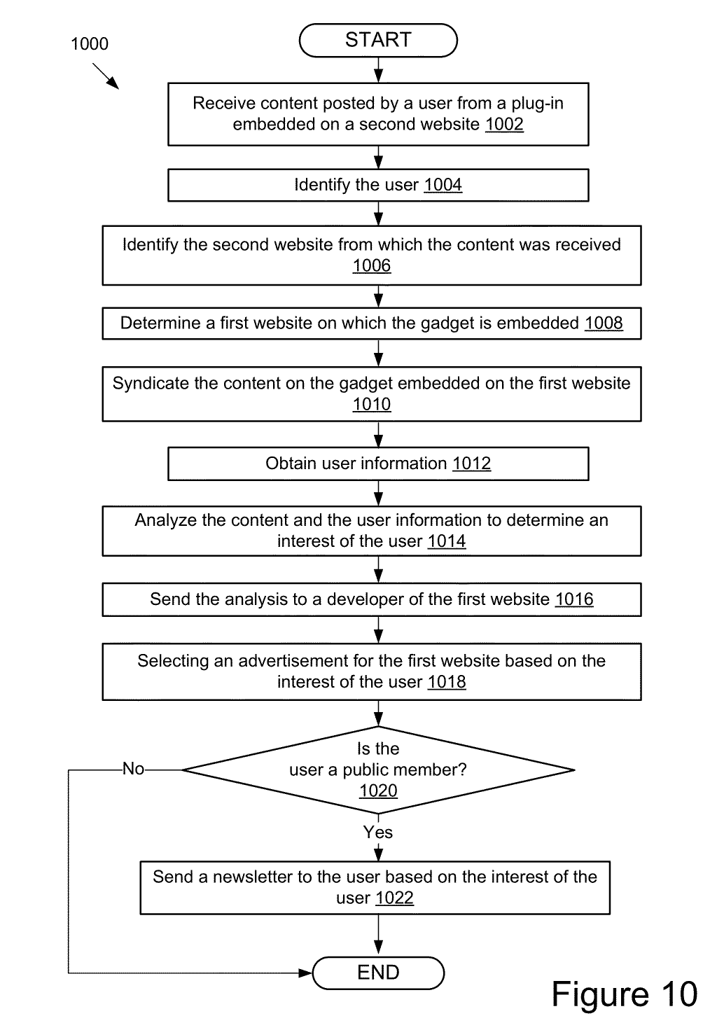

Referring now to FIGS. 9-10, various embodiments of the methods for syndicating content will be described. FIG. 9 is a flow diagram 900 illustrating a first embodiment for syndicating content received by a gadget that is embedded on different websites. The content parser 215 receives 902 via the communication unit 240 content posted by a user from a gadget embedded on a website. The received content is text, audio, video, a photo, a response to a poll or a questionnaire or any other content known to a person with ordinary skill in the art. The content parser 215 identifies 904 the user that submitted the content and the website identifier associated with the website from which the content was received using the website identifier. The syndication module 217 receives the parsed content from the content parser 215 and determines 906 other websites on which the gadget is embedded using the index. The index comprises an identifier of the gadget and the website identifiers of all the other websites. The syndication module 217 then syndicates 908 the received content on the gadget embedded on the other websites by transmitting the content for display on the other websites.

FIG. 10 is a flow diagram 1000 illustrating a second embodiment for syndicating content received by a gadget embedded on different websites. In this example, a developer of a second website embeds a gadget from a first website on to the second website. The content parser 215 receives 1002 content posted by a user from the gadget embedded on the second website. The content parser 215 identifies 1004 the user using the profile with which the user signs in to post the content. In this example the user signs in using the profile created by the profile engine 213. In another embodiment, the user signs in using an existing profile on the web, such as a social network profile. The content parser 215 also identifies 1006 the second website from which the content was received by parsing the website identifier from the content. The syndication module 217 receives the parsed content from the content parser 215 and determines 1008 the first website using the index and syndicates 1010 the content on the gadget embedded on the first website by transmitting the content to other websites that include the gadget. The gadget displays the content from the gadget on the first website.

The analysis engine 219 obtains 1012 user information of the user from the profile information, such as demographic information. The analysis engine 219 then analyzes 1014 the content and the user information to determine an interest of the user. In one embodiment, the analysis engine 219 uses the user information to predict the user's interests based on the interests of people with similar demographic information. In another embodiment, the analysis engine 219 determines the interest from content by inferring whether the user is making a positive or a negative statement. For example, if the content posted by the user on the second website is “Brand X shoes are the best, hope they open a store in Salt Lake City soon” the analysis engine 219 infers that the user from likes Brand X's shoes. The analysis engine 219 then sends 1016 the analysis to a developer of the first website. In one embodiment, this information is anonymized. In one embodiment, the analysis engine 219 transmits the analysis to all developers so that the developers can collectively learn about the gadget users. By collecting this information for multiple users, developers can learn about the interests of users that did not visit their website but who might be interested in their website.

The advertising engine 221 selects 1018 an advertisement for the first website based on the interest of the user. The advertising engine 221 will provide advertisements on Brand X shoes based on, for example, the gender of the user. The advertising engine 221 also provides advertisements of other stores within or nearby Salt Lake City that sell Brand X shoes. In one embodiment, the advertising engine 221 provides the advertisements to both the first and the second websites.

The newsletter engine 233 determines 1020 whether the user is a public member by verifying the profile of the user. If the user is a public member, the newsletter engine 233 sends 1022 a personalized newsletter to the user based on the interest of the user. The newsletter includes, for example, promotional offers, new products, website updates, topical news, etc. In one embodiment, the newsletter engine 233 generates and send newsletters to all the users of the website based on the inferences of content from all the users in general.

The foregoing description of the embodiments has been presented for the purposes of illustration and description. It is not intended to be exhaustive or to limit the description to the precise form disclosed. Many modifications and variations are possible in light of the above teaching. It is intended that the scope of the description be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the description can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to implementation in any specific programming language, or for any specific operating system or environment. Accordingly, the disclosure is intended to be illustrative, but not limiting, of the scope of the specification, which is set forth in the following claims.

What is claimed is:

1. A computer-implemented method for syndicating content received by a gadget, the method comprising:
receiving content posted by a user from the gadget embedded on a second website;
identifying the user;
identifying a first website on which the gadget is embedded; and
syndicating the content on the gadget embedded on the first website.

2. The computer-implemented method of claim 1, wherein syndicating the content comprises transmitting the content that is displayed on the second website to the first website for display.

3. The computer-implemented method of claim 1, further comprising obtaining user information from a user profile associated with the user; and
analyzing the content and the user information to generate an analysis that includes an interest of the user.

4. The computer-implemented method of claim 3, further comprising sending the analysis to a developer of the first website.

5. The computer-implemented method of claim 3, further comprising selecting an advertisement to the first website based on the interest of the user.

6. The computer-implemented method of claim 3, further comprising determining whether the user is a public member.

7. The computer implemented method of claim 6, wherein responsive to determining that the user is a public member, further comprising the steps of:
generating a newsletter for the user based on the interest of the user; and
sending the newsletter to the user.

8. The computer-implemented method of claim 1, further comprising generating a profile associated with the user that is accessible responsive to the user posting the content.

9. The computer-implemented method of claim 1, further comprising enabling the user to sign in using an existing profile on the web to post the content.

10. The computer-implemented method of claim 1, wherein the content is at least one from the group of text, video, audio, an image and a response to a poll or a questionnaire.

11. The computer implemented method of claim 1, further comprising the steps of:
authorizing a request from a developer of a third website to embed the gadget on the third website;
generating a website identifier for the third website;
generating a code for embedding the gadget on the third website; and
adding the website identifier of the third website to an index, the index including an identifier of the gadget, a website identifier of the first website and a website identifier of the second website.

12. A system for syndicating content received by a gadget, the system comprising:
a content parser for receiving content posted by a user from the gadget embedded on a second website, identifying the user and identifying a first website on which the gadget is embedded; and
a syndication module coupled to the content parser, the syndication module for syndicating the content on the gadget embedded on the first website.

13. The system of claim 12, wherein the content is syndicated by transmitting the content that is displayed on the second website to the first website for display

14. The system of claim 12, further comprising an analysis engine coupled to the content parser, the analysis engine for obtaining user information, for analyzing the content and the user information to generate an analysis that includes an interest of the user and for transmitting the analysis to a developer of the first website.

15. The system of claim 14, further comprising an advertising engine coupled to the analysis engine, the advertising engine for selecting an advertisement to the first website based on the interest of the user.

16. The system of claim 14, further comprising a newsletter engine coupled to the analysis engine, the newsletter engine for determining whether the user is a public member.

17. The system of claim 16, wherein the newsletter engine further generates and sends a newsletter to the user based on the interest of the user responsive to determining that the user is a public member.

18. The system of claim 12, further comprising a profile engine coupled to the content parser, the profile engine for generating a profile for the user to sign in and post the content.

19. The system of claim 12, further comprising an authorization module coupled to the syndication module, the authorization module for authorizing a request from a developer of a third website to embed the gadget on the third website.

20. The system of claim 19, further comprising a code generator coupled to the authorization module, the code generator for generating a code for embedding the gadget on the third website.

21. The system of claim 19, further comprising an identity generator coupled to the authorization module, the identity generator for creating a website identifier for the third website and adding the website identifier of the third website to an index, the index including an identifier of the gadget, an identifier of the first website and an identifier of the second website.

22. A computer program product comprising a computer useable medium including a computer readable program, wherein the computer readable program when executed on a computer causes the computer to:
receive content posted by a user from a gadget embedded on a second website;
identify the user;
identify a first website on which the gadget is embedded; and
syndicate the content on the gadget embedded on the first website.
